(19) United States
(12) Patent Application Publication
(10) Pub. No.: US 2019/0377793 A1
(43) Pub. Date: Dec. 12, 2019

(54) METHOD AND APPARATUS FOR ESTABLISHING A HIERARCHICAL INTENT SYSTEM

(71) Applicant: Alibaba Group Holding Limited, Grand Cayman (KY)

(72) Inventors: Ling LI, Hangzhou (CN); Zhiwei Shi, Hangzhou (CN)

(21) Appl. No.: 16/238,695

(22) Filed: Jan. 3, 2019

(30) Foreign Application Priority Data
Jun. 7, 2018 (CN) 201810580085.3

(51) Int. Cl. G06F 17/27; G06N 20/00

(52) U.S. Cl. CPC G06F 17/2785; G06N 20/00; G06F 17/2735

(57) ABSTRACT

Embodiments of the present invention provide a method of establishing a hierarchical intent system, comprising: obtaining, by a processor, a user intent corpus; identifying, by the processor, a plurality of text statements in the user intent corpus; generating, by the processor, sentence vectors corresponding to each of the plurality of text statements; obtaining, by the processor, a plurality of clusters by clustering a plurality of the sentence vectors; identifying, by the processor, text statement sets corresponding to each of the plurality of clusters; and establishing, by the processor, a hierarchical intent system utilizing the identified text statement sets.

### CROSS-REFERENCE TO RELATED APPLICATIONS

This application claims the benefit of priority of Chinese Application No. 201810580085.3, titled “METHOD AND APPARATUS FOR ESTABLISHING A HIERARCHICAL INTENT SYSTEM,” filed on Jun. 7, 2018, which is hereby incorporated by reference in its entirety.

### BACKGROUND

### Technical Field

The disclosed embodiments are directed to the field of natural language processing, and in particular, methods and apparatuses for establishing a hierarchical intent system.

### Description of the Related Art

Currently, one important module in a robotic customer service system is an “intent identification” module. Customer service robots need to identify the intent included in a user session and respond to the user session accordingly based on the identified intent. Therefore, the accuracy of “intent identification” directly affects the efficiency and accuracy of downstream components employed by the customer service robot and also plays an important role in the overall processing operations of the robot.

User intent data used in intent identification is usually obtained by service experts through service-based processing, which consumes significant manpower. Therefore, an improved, technical solution is needed to identify large amounts of user intent data in an accurate, fast, and comprehensive manner.

### SUMMARY

Disclosed are methods of establishing a hierarchical intent system. By clustering texts in an obtained user intent corpus, the disclosed embodiments are able to mine user intent data under different granularities needed for constructing a hierarchical intent system.

In one embodiment, a method is disclosed comprising obtaining, by a processor, a user intent corpus; identifying, by the processor, a plurality of text statements in the user intent corpus; generating, by the processor, sentence vectors corresponding to each of the plurality of text statements; obtaining, by the processor, a plurality of clusters by clustering a plurality of the sentence vectors; identifying, by the processor, text statement sets corresponding to each of the plurality of clusters; and establishing, by the processor, a hierarchical intent system utilizing the identified text statement sets.

In one embodiment, the obtaining a user intent corpus comprising obtaining session data associated with a plurality of historical user sessions. In one embodiment, the identifying a plurality of text statements in the user intent corpus comprising: pre-processing the plurality of historical user sessions, the pre-processing including pre-processing selected from the group consisting of deleting data in a predetermined category from the plurality of historical user sessions and deleting data from the plurality of historical user sessions based on a pre-determined maximum length; and identifying the plurality of text statements according to the pre-processed historical user sessions. In one embodiment, the generating sentence vectors comprising: performing word segmentation on each of the plurality of text statements to obtain word segment sets corresponding to each of the plurality of text statements; determining a word vector for each word segment in the word segment sets using a pre-trained word vector model; and determining each of the corresponding sentence vectors based on the word vector of each word segment. In one embodiment, the performing word segmentation comprising utilizing a word segmentation algorithm or tool selected from a group of algorithms or tools consisting of dictionary-based word segmentation algorithms, inverse maximum matching methods, two-way matching word segmentation methods, statistical-based machine learning algorithms, and deep learning algorithms. In one embodiment, the determining each of the corresponding sentence vectors comprising calculating a sum vector of a plurality of word vectors corresponding to each of the word segment sets and using the sum vector as each corresponding sentence vector. In one embodiment, the identifying text statement sets comprising: determining, based on mapping relationships generated using the pre-trained word vector model and according to each set of word vectors corresponding to each sentence vector in each of the plurality of clusters, each word segment set corresponding to each set of word vectors; and determining a text statement corresponding to each word segment set. In one embodiment, the method further comprising generating the pre-trained word vector model using a word representation algorithm and training corpora. In one embodiment, the clustering a plurality of the sentence vectors comprising clustering the sentence vectors using clustering algorithms selected from the group consisting of k-means, DBSCAN, k-medoids, CLARANS, BIRCH, CURE, CHAMELEON, OPTICS, and DENCLUE algorithms.

In another embodiment, disclosed is an apparatus comprising: a processor; and a storage medium for tangibly storing thereon program logic for execution by the processor, the stored program logic comprising: logic, executed by the processor, for obtaining a user intent corpus; logic, executed by the processor, for identifying a plurality of text statements in the user intent corpus; logic, executed by the processor, for generating sentence vectors corresponding to each of the plurality of text statements; logic, executed by the processor, for obtaining a plurality of clusters by clustering a plurality of the sentence vectors; logic, executed by the processor, for identifying text statement sets corresponding to each of the plurality of clusters; and logic, executed by the processor, for establishing a hierarchical intent system utilizing the identified text statement sets.

In one embodiment, the logic for obtaining a user intent corpus comprising logic, executed by the processor, for obtaining session data associated with a plurality of historical user sessions. In one embodiment, the logic for identifying a plurality of text statements in the user intent corpus comprising: logic, executed by the processor, for pre-processing the plurality of historical user sessions, the pre-processing including pre-processing selected from the group consisting of deleting data in a predetermined category from the plurality of historical user sessions and deleting data from the plurality of historical user sessions based on a pre-determined maximum length; and logic, executed by the processor, for identifying the plurality of text statements according to the pre-processed historical user sessions. In one embodiment, the logic for generating sentence vectors comprising: logic, executed by the processor, for performing word segmentation on each of the plurality of text statements to obtain word segment sets corresponding to each of the plurality of text statements; logic, executed by the processor, for determining a word vector for each word segment in the word segment sets using a pre-trained word vector model; and logic, executed by the processor, for determining each of the corresponding sentence vectors based on the word vector of each word segment. In one embodiment, the logic for performing word segmentation comprising logic, executed by the processor, for utilizing a word segmentation algorithm or tool selected from a group of algorithms or tools consisting of dictionary-based word segmentation algorithms, inverse maximum matching methods, two-way matching word segmentation methods, statistical-based machine learning algorithms, and deep learning algorithms. In one embodiment, the logic for determining each of the corresponding sentence vectors comprising logic, executed by the processor, for calculating a sum vector of a plurality of word vectors corresponding to each of the word segment sets and using the sum vector as each corresponding sentence vector. In one embodiment, the logic for identifying text statement sets comprising: logic, executed by the processor, for determining, based on mapping relationships generated using the pre-trained word vector model and according to each set of word vectors corresponding to each sentence vector in each of the plurality of clusters, each word segment set corresponding to each set of word vectors; and logic, executed by the processor, for determining a text statement corresponding to each word segment set. In one embodiment, the stored program logic further comprising logic, executed by the processor, for generating the pre-trained word vector model using a word representation algorithm and training corpora. In one embodiment, the logic for clustering a plurality of the sentence vectors comprising logic, executed by the processor, for clustering the sentence vectors using clustering algorithms selected from the group consisting of k-means, DBSCAN, k-medoids, CLARANS, BIRCH, CURE, CHAMELEON, OPTICS, and DENCLUE algorithms.

In another embodiment, a non-transitory computer readable storage medium for tangibly storing computer program instructions capable of being executed by a computer processor is disclosed. In this embodiment, the computer program instructions defines the steps of: obtaining a user intent corpus; identifying a plurality of text statements in the user intent corpus; generating sentence vectors corresponding to each of the plurality of text statements; obtaining a plurality of clusters by clustering a plurality of the sentence vectors; identifying text statement sets corresponding to each of the plurality of clusters; and establishing a hierarchical intent system utilizing the identified text statement sets. In one embodiment, the computer program instructions further defining the steps of: performing word segmentation on each of the plurality of text statements to obtain word segment sets corresponding to each of the plurality of text statements; determining a word vector for each word segment in the word segment sets using a pre-trained word vector model; and determining each of the corresponding sentence vectors based on the word vector of each word segment.

In the method of establishing a hierarchical intent system disclosed in the embodiments of the present disclosure: first, a user intent corpus is obtained; a plurality of text statements corresponding to the user intent corpus are determined; next, each sentence vector corresponding to each of the plurality of text statements is determined; then a plurality of clusters are obtained by clustering a plurality of sentence vectors; and then each text statement set corresponding to each of the plurality of clusters is determined; a person skilled in the art is then able to determine, based on each of the text statement sets, each of user intents corresponding thereto and establish the hierarchical intent system according to a plurality of determined user intents.

### BRIEF DESCRIPTION OF THE DRAWINGS

To illustrate the technical solutions in the embodiments, the drawings used in the description of the embodiments are introduced briefly in the following description. The drawings described below are merely some of the disclosed embodiments and those of ordinary skill in the art may still derive other drawings from these drawings without significant effort.

FIG. 1 is a flow diagram illustrating a method for identifying user intent from a corpus of documents according to some embodiments of the disclosure.

FIG. 2 is a flow diagram illustrating a method of establishing a hierarchical intent system according to some embodiments of the disclosure.

FIGS. 3-5 are diagrams of hierarchical intents according to some embodiments of the disclosure.

FIG. 6 is a block diagram illustrating an apparatus for establishing a hierarchical intent system according to some embodiments of the disclosure.

### DETAILED DESCRIPTION OF THE EMBODIMENTS

The disclosed embodiments are described below with reference to the accompanying drawings.

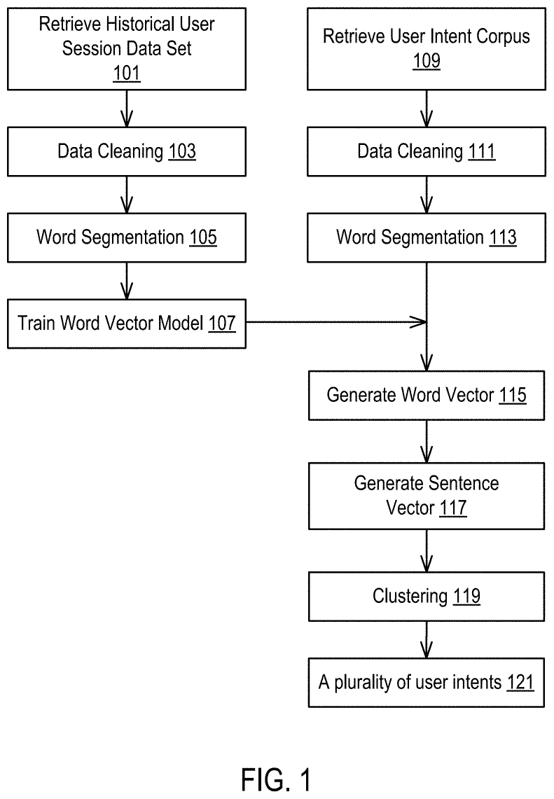

FIG. 1 is a flow diagram illustrating a method for identifying user intent from a corpus of documents according to some embodiments of the disclosure.

As shown in FIG. 1, a word vector model for representing words as vectors is trained (107) based on a retrieved (101) historical user session data set. The historical user session data set is composed of a plurality of historical user sessions corresponding to a plurality of historical customer services. Specifically, in one embodiment, the method performs data cleaning (103) on a plurality of historical user sessions. In one embodiment, data cleaning comprises removing non-text data in historical user sessions (e.g., website addresses). Next, the method performs word segmentation (105) on the historical user sessions which have been subject to data cleaning, obtaining a plurality of word segments. For example, the method can perform word segmentation using a word segmenter and can obtain a word vector model by adopting an unsupervised training method according to the obtained plurality of word segments and a word representation algorithm. In one embodiment, the word representation algorithm can be a word2vec algorithm and the method can obtain a word vector model based on the word2vec algorithm.

Afterwards, the method determines a plurality of user intents (121) corresponding to a retrieved (109) user intent corpus based on at least a pre-trained word vector model. The user intent corpus can comprise some of session data extracted from the above-mentioned historical user session data set. Specifically, in one embodiment, the method performs data cleaning (111) on a user intent corpus and a plurality of text statements corresponding to the user intent corpus (e.g., “please help cancel the order” and “when will there be a diaper promotion”) may be determined. Next, the method performs word segmentation on the plurality of text statements (113) and obtains each word segment set corresponding to each of the plurality of text statements. Then, the method generates a word vector corresponding to each word segment in each of the word segment sets by utilizing a pre-trained word vector model (115). Next, the method generates a sentence vector corresponding to a text statement utilizing the word vectors corresponding to each of the word segment sets (117). For example, the method can sum and average a plurality of word vectors in each of the word segment sets; then, the method can cluster the plurality of sentence vectors (119) to obtain a plurality of clusters and identify each text statement set corresponding to each of the plurality of clusters according to the plurality of clusters. In this way, a person skilled in the art can determine, based on each text statement set obtained by means of clustering, each user intent corresponding thereto, thereby establishing a hierarchical intent system according to the determined plurality of user intents. Specific implementation steps of the above-mentioned process will be described below in further detail.

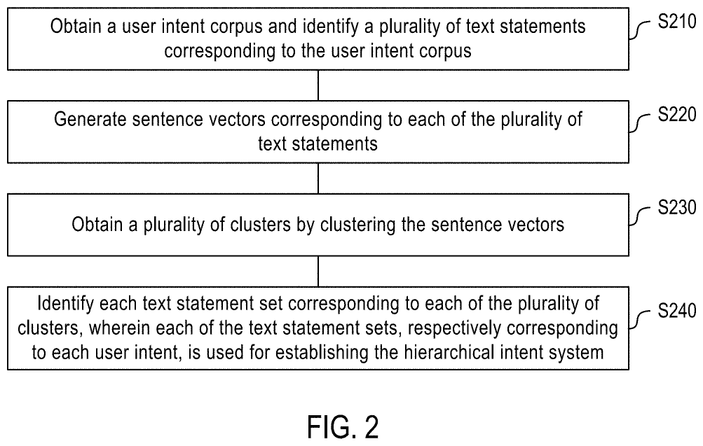

FIG. 2 is a flow diagram illustrating a method of establishing a hierarchical intent system according to some embodiments of the disclosure.

A device having processing capabilities (e.g., a server, a system, or an apparatus) may execute the method illustrated in FIG. 2. As illustrated, the method comprises the following steps: obtaining a user intent corpus and identifying a plurality of text statements corresponding to the user intent corpus (step S210); generates sentence vectors corresponding to each of the plurality of text statements (step S220); obtaining a plurality of clusters by clustering the sentence vectors (step S230); and identifying each text statement set corresponding to each of the plurality of clusters, wherein each of the text statement sets, respectively corresponding to each user intent, is used for establishing the hierarchical intent system (step S240). Details of these steps are provided in more detail herein.

In step S210, the method obtains a user intent corpus and identifies a plurality of text statements corresponding to the user intent corpus.

In one embodiment, the obtained user intent corpus includes a plurality of historical user sessions in a plurality of historical customer services. For example, the obtained user intent corpus can include some session data from the above-mentioned historical user session data set. In one example, the plurality of historical user sessions may include: “how come the seller has not refunded?”, “not receiving goods”, “can I cancel the order?” and the like. In another embodiment, the obtained user intent corpus may include a service category data set provided by a service provider. In one example, the service category may include a broad category representing a relatively broad scope of services and a narrow category representing a relatively narrower scope of service. For example, the broad category may comprise a category of maternity and babies while the narrow category includes formula, diapers, bottles, and the like.

In one embodiment, the user intent corpus may comprise a plurality of historical user sessions; and determining a plurality of text statements corresponding to the user intent corpus may comprise: pre-processing the plurality of historical user sessions; and identifying, according to the pre-processed historical user sessions, the plurality of text statements. Specifically, in one example, pre-processing the plurality of historical user sessions may comprise: deleting data in a predetermined category from the plurality of historical user sessions. For example, special symbols (e.g., [symbol] , [symbol] ), expressions, website addresses included in each historical user session may be deleted. For another example, historical user sessions exceeding a predetermined number of characters (e.g., 20 characters), such as “although it rains heavily today, it is about time to deliver the goods I ordered” may be deleted. In the previous examples, the special symbols, expressions, and website addresses are deleted because of the limited user intent they may include. In other words, the previous examples generally do not include useful information related to a user intent. The primary reason to delete long sentences is that long sentences usually include fewer words that reflect a user intent. If long sentences are kept, subsequent calculations on long sentences will consume significant resources. Therefore, long sentences can be directly deleted.

On the other hand, as one example, determining, based on the plurality of pre-processed historical user sessions, a plurality of text statements corresponding thereto may comprise: using each of the plurality of pre-processed historical user sessions as a corresponding text statement. In another example, determining a plurality of corresponding text statements may comprise: dividing, according to a predetermined punctuation mark (e.g., commas and periods), each of the pre-processed historical user sessions into corresponding text statements. For example, a pre-processed historical user session “I have not received the goods, I want a refund” may be divided into “I have not received the goods” and “I want a refund.”

In another embodiment, the user intent corpus may comprise a plurality of service categories provided by a service provider; and accordingly, determining a plurality of text statements corresponding to the user intent corpus may comprise: using each of the plurality of service categories as a corresponding text statement. In one example, a service category “**Infant Formula Stage 3” may be used as a text statement.

In view of the above, the plurality of text statements corresponding to the obtained user intent corpus can be determined.

In step S220, the method generates sentence vectors corresponding to each of the plurality of text statements.

In one embodiment, generating sentence vectors corresponding to each of the plurality of text statements may comprise: first, performing word segmentation on each of the plurality of text statements to obtain word segment sets corresponding to each of the plurality of text statements; next, determining, based on a pre-trained word vector model, a word vector for each word segment in the word segment sets; and then determining, based on the word vector of each word segment, each of the corresponding sentence vectors.

Word segmentation can be performed on each of the plurality of text statements by using various word segmentation algorithms or various word segmentation tools. As one example, the various word segmentation algorithms may include: a dictionary-based word segmentation algorithm (such as a forward maximum matching method), an inverse maximum matching method, and a two-way matching word segmentation method. Alternatively, the various word segmentation algorithms may include a statistical-based machine learning algorithm (such as HMM, CRF, SVM, etc.), deep learning, and other algorithms. In one example, word segmentation is performed on the text statement “not receiving goods” and the obtained word segment set may be {“not”, “receiving”, “goods”}. In another example, word segmentation is performed on the text statement “Infant Formula Stage 3” and the obtained word segment set may be {“Infant”, “Formula”, “Stage 3”}. Accordingly, the word segment sets corresponding to each of the plurality of text statements can be obtained.

In addition, the vector model can be obtained by performing training based on a word representation algorithm. On one hand, the training on the word vector model may be carried out in an unsupervised manner. Further, in one example, a large amount of training corpora used in the training may include data from multiple websites (e.g., data from Baidu Knows). In another example, a large amount of training corpora used in training may comprise the aforementioned historical user session data set. On the other hand, the word representation algorithm may be a word2vec algorithm and a Global Vectors for Word Representation (GloVe) algorithm; and the word vector model obtained accordingly is a word2vec algorithm-based word vector model and a GloVe algorithm-based word vector model. Word2vec is an efficient tool to represent words as real-value vectors open-sourced by Google, Inc. of Mountain View, Calif. in 2013. The processing of text content can be simplified through deep learning and training by turning the processing into vector operations in a k-dimensional vector space. A distance in the vector space can be used to represent a semantic similarity of texts. GloVe is a tool that Stanford University of Stanford, Calif. has open sourced for vectorizing words. GloVe enables vectors to include as much semantic and grammatical information as possible with the use of overall statistics features of a corpus and local context features (i.e., sliding windows). In this way, the word vector of each word segment in the word segment sets can be determined.

Further, in one embodiment, determining, based on the word vector for each word segment in each of the word segment sets, a corresponding sentence vector for each text statement may comprise: calculating a sum vector of a plurality of word vectors corresponding to each of the word segment sets and using the sum vector as each corresponding sentence vector. In another embodiment, determining the corresponding sentence vector for each text statement may comprise: calculating an average vector for the plurality of word vectors corresponding to each of the word segment sets and using the average vector as each corresponding sentence vector.

In view of the above, a plurality of sentence vectors corresponding to the plurality of text statements can be determined.

In step S230, the method obtains a plurality of clusters by clustering a plurality of sentence vectors.

In one embodiment, the plurality of sentence vectors may be clustered using a k-means algorithm. A k-means algorithm is a partition-based clustering algorithm. In one example, the specific implementation process can comprise the following steps:
1) At the beginning of clustering, k objects are randomly selected from a sentence vector set according to a cluster number k preset manually; and these objects are used as a mean value of k initial clusters (i.e., a central object).
2) Each object remaining in the sentence vector set is divided and put into the nearest cluster according to the Euclidean distance of the object to each cluster center.
3) After all objects are distributed, a mean value of each cluster is recalculated, then a distance of each text to the mean values or centers of these new clusters is calculated; and the text is re-categorized into the currently-nearest cluster.
4) Steps (2) and (3) described above are repeated until all samples cannot be redistributed.

It should be noted that the cluster number k can be set by relevant service personnel according to the number of the plurality of text statements and the personnel's service experience.

In another embodiment, a density-based spatial clustering of applications with noise (DBSCAN) algorithm may be employed to cluster the plurality of sentence vectors corresponding to the plurality of text statements. The DBSCAN algorithm is a density-based clustering algorithm. Unlike partitioning and hierarchical clustering methods, in the DBSCAN algorithm, a cluster is defined as a maximum set of points with connected densities; an area with a sufficient high density can be divided into clusters; and clusters in arbitrary shapes can be found in a spatial database of noises. Specifically, in the DBSCAN algorithm, all position points are marked as core points, boundary points, or noise points; and the noise points are deleted. Second, an edge is assigned among all core points having a distance within a preset parameter (i.e., a neighborhood radius E); each set of connected core points form a cluster; each boundary point is assigned to a cluster of a core point associated therewith, to complete clustering of position points. A larger preset parameter results in a smaller number of clusters obtained through clustering; on the other hand, a smaller preset parameter results in a larger number of obtained clusters.

It can be understood that in this step, the sentence vectors for the plurality of text statements can also be clustered using other various clustering algorithms. The various clustering algorithms may include: partitioning clustering algorithms like k-medoids algorithm, CLARANS (Clustering Large Applications based on RANdomized Search) algorithm, and the like; hierarchical clustering algorithms like BIRCH (balanced iterative reducing and clustering using hierarchies) algorithm, CURE (Clustering Using REpresentatives) algorithm, CHAMELEON algorithm, and the like; and density-based clustering algorithms like OPTICS (Ordering points to identify the clustering structure) algorithm, DENCLUE (DENsity CLUstering) algorithm, and the like.

From the above, by clustering the plurality of sentence vectors corresponding to the plurality of text statements, it is possible to obtain the corresponding plurality of clusters.

In step S240, the method identifies each text statement set corresponding to each of the plurality of clusters, wherein each of the text statement sets, respectively corresponding to each user intent, is used for establishing the hierarchical intent system.

In one embodiment, the above-mentioned pre-trained word vector model comprises a mapping relationship between a word segment and a word vector. Step S240 may accordingly comprise: first, determining, based on the mapping relationships and according to each set of word vectors corresponding to each sentence vector in each of the plurality of clusters, each word segment set corresponding to each set of word vectors; and then determining a text statement corresponding to each word segment set. That is, word segments in each of the word segment sets are sequentially combined to obtain a corresponding text statement; and using a plurality of text statements corresponding to each of the clusters as each of the text statement sets.

In view of the above, a plurality of text statement sets corresponding to the plurality of clusters can be obtained.

It should be noted that after step S240, the method may further comprise: providing the plurality of text statement sets to a person skilled in the art, so that the person skilled in the art determines each user intent corresponding to each of the text statement sets.

According to one embodiment, each text statement set comprises a plurality of text statements. A person skilled in the art could determine a corresponding user intent according to these text statements. For example, assume that a text statement set comprises the following text statements: “please help to see where my package is?”, “check the status of my order number,” “please provide the logistics information of my package” and so on. Based on this, a person skilled in the art could determine that a user intent corresponding to this text statement set is “check package”. In this way, a plurality of user intents corresponding to a plurality of text statement sets can be determined for establishing a hierarchical intent system.

Further, in one embodiment, after the plurality of user intents are determined, a person skilled in the art could also establish a hierarchical intent system based on an observed hierarchical relationship between the user intents.

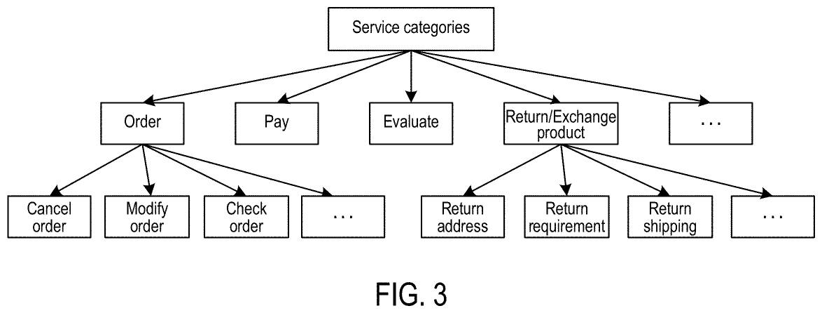

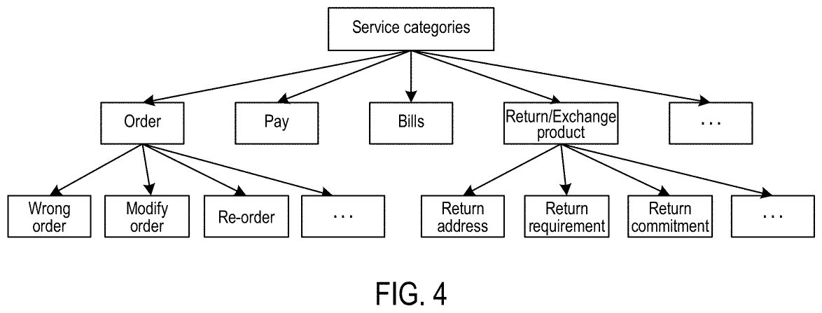

In one example, a person skilled in the art could establish a hierarchical intent system in a top-down or bottom-up manner. In one specific example, establishing a hierarchical intent system in a top-down manner means the following: a person skilled in the art could first determine a user intent identified by a top-level parent node based on a plurality of user intents, and then determine a user intent identified by a child node layer by layer in a downward manner. For example, the hierarchical intent system established in this manner may include the hierarchical intent shown in FIG. 3. In another example, establishing a hierarchical intent system in a bottom-up manner means the following: a person skilled in the art could first determine a user intent identified by a bottom-level child node, and then determine a user intent identified by a parent node layer by layer in an upward manner. For example, the hierarchical intent system established in this manner may include the hierarchical intent shown in FIG. 4.

It should be noted that according to actual service experience, when a plurality of user intents is determined based on a plurality of pieces of historical user session data, it is usually possible to obtain multiple batches of clusters with different numbers by controlling clustering parameters. When the number of clusters obtained by clustering is relatively large, the granularity of the accordingly determined user intent is relatively fine, and when the number of clusters obtained by clustering is relatively small, the granularity of the accordingly determined user intent is relatively coarse. As such, a person skilled in the art could first determine an upper part of the hierarchical intent system based on a user intent having a relatively coarse granularity, and then determine a lower part of the hierarchical intent system based on the upper part and a user intent having a relatively fine granularity, thereby realizing the establishment of the hierarchical intent system in a top-down manner.

By contrast, because the granularity of a service category itself is relatively fine, it is possible to obtain more clusters by controlling clustering parameters upon clustering when a plurality of user intents is determined based on a plurality of service categories. More fine-grained user intents can then be obtained; and a hierarchical intent system is established in a bottom-up manner based on these fine-grained user intents.

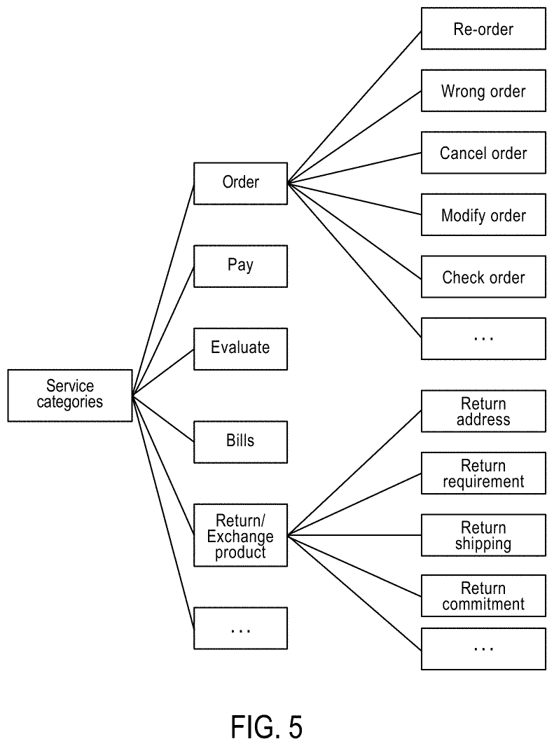

In one specific example, a first hierarchical intent system can be established based on a plurality of user intents corresponding to a plurality of historical user sessions and a second hierarchical intent system can be established based on a plurality of user intents corresponding to a plurality of service categories; and then the first hierarchical intent system and the second hierarchical intent system are modified (for example, the modification may include supplementing, trimming, and combining) to obtain a final hierarchical intent system. For example, a final hierarchical intent system shown in FIG. 5 can be established according to the hierarchical intents shown in FIGS. 3 and 4.

In this way, a hierarchical intent system can be established manually based on a plurality of determined user intents. Since parent intent node information in the hierarchical intent system can be utilized in intent identification, the accuracy of intent identification is higher; and a hierarchical intent structure facilitates the maintenance. Through this semi-automatic establishment method, the efficiency of establishing an intent system can be greatly improved; the quality of an intent can be ensured; the accuracy of intent identification can be improved; and as a result, the overall effect of a customer service robot can be improved.

To summarize, when adopting the method of establishing a hierarchical intent system provided in the embodiment of the disclosure: first, a user intent corpus is obtained; a plurality of text statements corresponding to the user intent corpus are determined; next, each sentence vector corresponding to each of the plurality of text statements is determined; then a plurality of clusters are obtained by clustering a plurality of sentence vectors; and then each text statement set corresponding to each of the plurality of clusters is determined; a person skilled in the art is then able to determine, based on each of the text statement sets, each of user intents corresponding thereto and establish the hierarchical intent system according to a plurality of determined user intents.

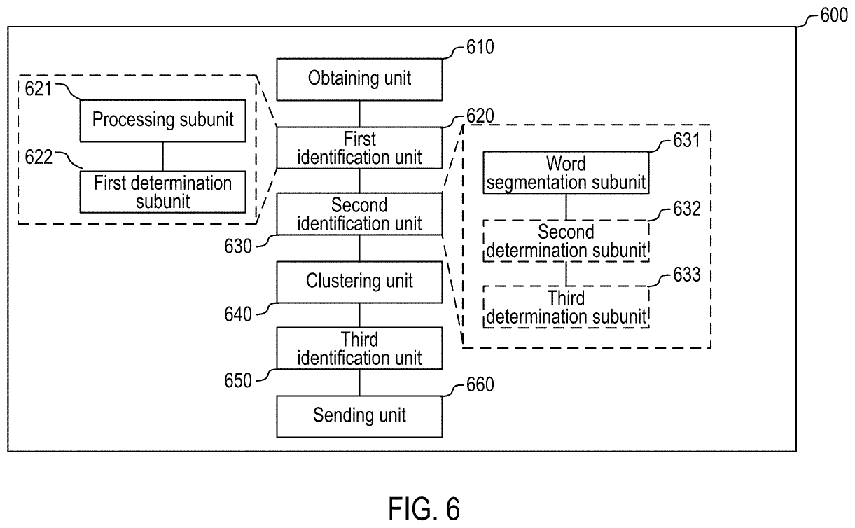

FIG. 6 is a block diagram illustrating an apparatus for establishing a hierarchical intent system according to some embodiments of the disclosure.

As shown in FIG. 6, the apparatus 600 comprises: an obtaining unit 610, configured for obtaining a user intent corpus; a first identification unit 620, configured for identifying a plurality of text statements corresponding to the user intent corpus; a second identification unit 630, configured for identifying each sentence vector corresponding to each of the plurality of text statements; a clustering unit 640, configured for obtaining a plurality of clusters by clustering a plurality of sentence vectors; and a third identification unit 650, configured for identifying each text statement set corresponding to each of the plurality of clusters, wherein each of the text statement sets, respectively corresponding to each user intent, is used for establishing the hierarchical intent system.

According to one embodiment, the hierarchical intent system comprises a plurality of parent node user intents and a plurality of child node user intents corresponding to each of the plurality of parent node user intents.

According to one embodiment, the user intent corpus obtained by the obtaining unit 610 comprises a plurality of historical user sessions corresponding to a plurality of historical customer services; and the first identification unit 620 specifically comprises: a processing subunit 621, configured for pre-processing the plurality of historical user sessions; and a first determination subunit 622, configured for determining, according to pre-processed historical user sessions, the plurality of text statements.

Further, in one embodiment, the processing subunit 621 is specifically configured for: deleting data in a predetermined category in the plurality of historical user sessions, wherein the data in the predetermined category comprises at least one of special symbols, expressions, website addresses, and historical user sessions exceeding a predetermined number of characters.

According to one embodiment, the user intent corpus obtained by the obtaining unit 610 comprises a plurality of service categories; and the first identification unit 620 is specifically configured for: using each of the plurality of service categories as a corresponding text statement.

According to one embodiment, the second identification unit 630 specifically comprises: a word segmentation subunit 631, configured for performing word segmentation on each of the plurality of text statements to obtain word segment sets corresponding to each of the plurality of text statements; a second determination subunit 632, configured for determining, based on a trained word vector model, a word vector for each word segment in the word segment sets; and a third determination subunit 633, configured for determining, based on the word vector of each word segment, each of the sentence vectors.

Further, in one embodiment, the word vector model in the second determination subunit 632 comprises a word2vec algorithm-based word vector model or a GloVe algorithm-based word vector model.

In another aspect, in one embodiment, the word vector model in the second determination subunit 632 comprises a mapping relationship between the word segment and the word vector; and the third identification unit 650 is specifically configured for: determining, based on the mapping relationships and according to each set of word vectors corresponding to each sentence vector in each of the plurality of clusters, each word segment set corresponding to each set of word vectors; and determining each text statement corresponding to each of the word segment sets, and using the plurality of text statements corresponding to the plurality of sentence vectors comprised in each of the plurality of clusters as each of the text statement sets.

In one embodiment, the third determination subunit 633 is specifically configured for: calculating a sum vector/average vector of a plurality of word vectors corresponding to the word segment sets, and using the sum vector/average vector as each corresponding sentence vector.

According to one embodiment, the clustering unit 640 is specifically configured for: clustering, based on a clustering algorithm, the plurality of sentence vectors, wherein the clustering algorithm comprises at least one of a partitional clustering algorithm, a hierarchical clustering algorithm, and a density-based clustering algorithm.

According to one embodiment, the apparatus further comprises: a sending unit 660, configured for providing each of the text statement sets to a person skilled in the art, so that the person skilled in the art determines each of user intents corresponding to each of the text statement sets; and establishing, according to a plurality of determined user intents, the hierarchical intent system.

To summarize, when adopting the apparatus of establishing a hierarchical intent system provided in the embodiment of the present disclosure: first, a user intent corpus is obtained by the obtaining unit 610; a plurality of text statements corresponding to the user intent corpus are determined by the first identification unit 620; next, each sentence vector corresponding to each of the plurality of text statements is determined by the second identification unit 630; then a plurality of clusters are obtained by clustering a plurality of sentence vectors using the clustering unit 640; and then each text statement set corresponding to each of the plurality of clusters is determined by the third identification unit 650; a person skilled in the art is then able to determine, based on each of the text statement sets, each of user intents corresponding thereto and establish the hierarchical intent system according to a plurality of determined user intents.

As above, according to another aspect, a computer-readable storage medium is further provided; the computer-readable storage medium having stored thereon a computer program for enabling a computer to perform the method described in conjunction with FIGS. 1 and 2 when the computer program is executed in the computer.

According to still another aspect, a computing device comprising a memory and a processor is further provided, wherein the memory having executable codes stored therein, and the processor implementing the method described in conjunction with FIG. 1 and FIG. 2 when executing the executable codes.

Those skilled in the art will appreciate that in one or more examples described above, the functions described in various embodiments disclosed herein can be implemented through hardware, software, firmware, or any combination thereof. When implemented with software, the functions may be stored in a computer-readable medium or transmitted as one or more instructions or codes on a computer-readable medium.

The specific implementations described above further explain the objectives, technical solutions, and advantageous effects of the various embodiments disclosed herein. It should be understood that the above description is only the specific implementations of the various embodiments disclosed herein, and is not intended to limit the protection scope of the various embodiments disclosed herein. Any modifications, equivalents, improvements and the like made based on the technical solutions of the various embodiments disclosed herein should be under the protection scope of the various embodiments disclosed in the present disclosure.

What is claimed is:

1. A method comprising:
obtaining, by a processor, a user intent corpus;
identifying, by the processor, a plurality of text statements in the user intent corpus;
generating, by the processor, sentence vectors corresponding to each of the plurality of text statements;
obtaining, by the processor, a plurality of clusters by clustering a plurality of the sentence vectors;
identifying, by the processor, text statement sets corresponding to each of the plurality of clusters; and
establishing, by the processor, a hierarchical intent system utilizing the identified text statement sets.

2. The method of claim 1, the obtaining a user intent corpus comprising obtaining session data associated with a plurality of historical user sessions.

3. The method of claim 2, the identifying a plurality of text statements in the user intent corpus comprising:
pre-processing the plurality of historical user sessions, the pre-processing including pre-processing selected from the group consisting of deleting data in a predetermined category from the plurality of historical user sessions and deleting data from the plurality of historical user sessions based on a pre-determined maximum length; and
identifying the plurality of text statements according to the pre-processed historical user sessions.

4. The method of claim 1, the generating sentence vectors comprising:
performing word segmentation on each of the plurality of text statements to obtain word segment sets corresponding to each of the plurality of text statements;
determining a word vector for each word segment in the word segment sets using a pre-trained word vector model; and
determining each of the corresponding sentence vectors based on the word vector of each word segment.

5. The method of claim 4, the performing word segmentation comprising utilizing a word segmentation algorithm or tool selected from a group of algorithms or tools consisting of dictionary-based word segmentation algorithms, inverse maximum matching methods, two-way matching word segmentation methods, statistical-based machine learning algorithms, and deep learning algorithms.

6. The method of claim 4, the determining each of the corresponding sentence vectors comprising calculating a sum vector of a plurality of word vectors corresponding to each of the word segment sets and using the sum vector as each corresponding sentence vector.

7. The method of claim 4, the identifying text statement sets comprising:
determining, based on mapping relationships generated using the pre-trained word vector model and according to each set of word vectors corresponding to each sentence vector in each of the plurality of clusters, each word segment set corresponding to each set of word vectors; and
determining a text statement corresponding to each word segment set.

8. The method of claim 4, further comprising generating the pre-trained word vector model using a word representation algorithm and training corpora.

9. The method of claim 1, the clustering a plurality of the sentence vectors comprising clustering the sentence vectors using clustering algorithms selected from the group consisting of k-means, DBSCAN, k-medoids, CLARANS, BIRCH, CURE, CHAMELEON, OPTICS, and DENCLUE algorithms.

10. An apparatus comprising:
a processor; and
a storage medium for tangibly storing thereon program logic for execution by the processor, the stored program logic comprising:
logic, executed by the processor, for obtaining a user intent corpus;
logic, executed by the processor, for identifying a plurality of text statements in the user intent corpus;
logic, executed by the processor, for generating sentence vectors corresponding to each of the plurality of text statements;
logic, executed by the processor, for obtaining a plurality of clusters by clustering a plurality of the sentence vectors;
logic, executed by the processor, for identifying text statement sets corresponding to each of the plurality of clusters; and
logic, executed by the processor, for establishing a hierarchical intent system utilizing the identified text statement sets.

11. The apparatus of claim 10, the logic for obtaining a user intent corpus comprising logic, executed by the processor, for obtaining session data associated with a plurality of historical user sessions.

12. The apparatus of claim 11, the logic for identifying a plurality of text statements in the user intent corpus comprising:
logic, executed by the processor, for pre-processing the plurality of historical user sessions, the pre-processing including pre-processing selected from the group consisting of deleting data in a predetermined category from the plurality of historical user sessions and deleting data from the plurality of historical user sessions based on a pre-determined maximum length; and
logic, executed by the processor, for identifying the plurality of text statements according to the pre-processed historical user sessions.

13. The apparatus of claim 10, the logic for generating sentence vectors comprising:
logic, executed by the processor, for performing word segmentation on each of the plurality of text statements to obtain word segment sets corresponding to each of the plurality of text statements;
logic, executed by the processor, for determining a word vector for each word segment in the word segment sets using a pre-trained word vector model; and
logic, executed by the processor, for determining each of the corresponding sentence vectors based on the word vector of each word segment.

14. The apparatus of claim 13, the logic for performing word segmentation comprising logic, executed by the processor, for utilizing a word segmentation algorithm or tool selected from a group of algorithms or tools consisting of dictionary-based word segmentation algorithms, inverse maximum matching methods, two-way matching word segmentation methods, statistical-based machine learning algorithms, and deep learning algorithms.

15. The apparatus of claim 13, the logic for determining each of the corresponding sentence vectors comprising logic, executed by the processor, for calculating a sum vector of a plurality of word vectors corresponding to each of the word segment sets and using the sum vector as each corresponding sentence vector.

16. The apparatus of claim 13, the logic for identifying text statement sets comprising:
logic, executed by the processor, for determining, based on mapping relationships generated using the pre-trained word vector model and according to each set of word vectors corresponding to each sentence vector in each of the plurality of clusters, each word segment set corresponding to each set of word vectors; and
logic, executed by the processor, for determining a text statement corresponding to each word segment set.

17. The apparatus of claim 13, the stored program logic further comprising logic, executed by the processor, for generating the pre-trained word vector model using a word representation algorithm and training corpora.

18. The apparatus of claim 10, the logic for clustering a plurality of the sentence vectors comprising logic, executed by the processor, for clustering the sentence vectors using clustering algorithms selected from the group consisting of k-means, DBSCAN, k-medoids, CLARANS, BIRCH, CURE, CHAMELEON, OPTICS, and DENCLUE algorithms.

19. A non-transitory computer readable storage medium for tangibly storing computer program instructions capable of being executed by a computer processor, the computer program instructions defining the steps of:
obtaining a user intent corpus;
identifying a plurality of text statements in the user intent corpus;
generating sentence vectors corresponding to each of the plurality of text statements;
obtaining a plurality of clusters by clustering a plurality of the sentence vectors;
identifying text statement sets corresponding to each of the plurality of clusters; and
establishing a hierarchical intent system utilizing the identified text statement sets.

20. The non-transitory computer-readable storage medium of claim 19, the computer program instructions further defining the steps of:
performing word segmentation on each of the plurality of text statements to obtain word segment sets corresponding to each of the plurality of text statements;
determining a word vector for each word segment in the word segment sets using a pre-trained word vector model; and
determining each of the corresponding sentence vectors based on the word vector of each word segment.
